(19) United States
(12) Patent Application Publication
(10) Pub. No.: US 2024/0267322 A1
(43) Pub. Date: Aug. 8, 2024

(54) NETWORK DEVICE FOR ENCODING AUTOMATIC PROTECTION SWITCHING INFORMATION AND OPERATING METHOD OF THE SAME

(71) Applicant: ELECTRONICS AND TELECOMMUNICATIONS RESEARCH INSTITUTE, Daejeon (KR)

(72) Inventors: Taesik CHEUNG, Daejeon (KR); Jeong-dong RYOO, Daejeon (KR)

(21) Appl. No.: 18/423,454

(22) Filed: Jan. 26, 2024

(30) Foreign Application Priority Data
Feb. 6, 2023 (KR) 10-2023-0015751
Oct. 6, 2023 (KR) 10-2023-0133673

(51) Int. Cl. H04L 45/28; H04L 41/0663; H04L 45/00

(52) U.S. Cl. CPC H04L 45/28; H04L 41/0663; H04L 45/22

(57) ABSTRACT

Provided are a network device for encoding automatic protection switching (APS) information and an operating method of the same. The operating method includes monitoring a state of a working path and, when a failure is detected on the working path, encoding network failure information for activating a protection path on an APS channel and transmitting the network failure information to another network device. The APS channel is divided into a plurality of fields. The plurality of fields includes a first field corresponding to at least one of failure state information and request state information, and the first field may be a field corresponding to protection type information.

### CROSS-REFERENCE TO RELATED APPLICATIONS

This application claims priority to and the benefit of Korean Patent Application No. 10-2023-0015751, filed on Feb. 6, 2023, and 10-2023-0133673, filed on Oct. 6, 2023, the disclosure of which is incorporated herein by reference in its entirety.

### BACKGROUND

### 1. Field of the Invention

The present disclosure relates to a technology for encoding automatic protection switching (APS) information, and more particularly, to a technology for encoding APS information required for an APS operation for ensuring high survivability of a network.

### 2. Description of Related Art

FIG. 1 is a diagram showing formats of an automatic protection switching (APS) channel, APS-specific information, and automatic protection coordination (APC)-specific information which are used in various transport networks, such as a synchronous digital hierarchy (SDH) network, an optical transport network (OTN), an Ethernet layer network (ETH), a metro transport network (MTN), a multi-protocol label switching transport profile (MPLS-TP) network, and the like, according to the related art.

Hereinafter, APS channels, APS-specific information, and APC-specific information may be collectively referred to as APS channels for convenience of description.

As shown in FIG. 1, APS channels according to the related art have sizes of two bytes to four bytes according to applied transport network technologies. All the APS channels are strictly divided into a type of request, request/state, or request field in which a switching request or state information is stored, a requested signal or fault path field and a bridged signal or data path field in which two pieces of signal information associated with a switch request are stored, and a protection type field required for mutual operations of protection switching.

### SUMMARY OF THE INVENTION

The present disclosure is directed to providing a method of minimizing the size of APS channel by defining a 1+1 protection switching method of a fine-grain optical transport network (fgOTN) and a fine-grain metro transport network (fgMTN), specifically, by defining a format different from those of APS channels according to the related art on the basis of a protection switching method according to the related art.

According to an aspect of the present disclosure, there is provided an operating method of a network device for encoding APS information, the operating method including monitoring a state of a working path and, when a failure is detected in the working path, encoding network failure information for activating a protection path on an APS channel and transmitting the network failure information to another network device. The APS channel is divided into a plurality of fields. The plurality of fields includes a first field corresponding to at least one of failure state information and request state information, and the first field may be a field corresponding to protection type information.

The protection type information may include at least one of information about whether to use APS channel and information about a switching type.

The information about whether to use APS channel may correspond to one of unused encoding values in the first field.

The information about the switching type may be determined on the basis of different encoding values which define predetermined request information.

The predetermined request information may be information that is associated with at least one of the failure state information and the request state information and may be an information having the lowest priority.

The APS channel may be associated with at least one of APS-specific information and APC-specific information.

According to another aspect of the present disclosure, there is provided a network device for encoding APS information, including a transceiver and at least one controller operatively connected to the transceiver. The at least one controller is configured to monitor a state of a working path and, when a failure is detected in the working path, encode network failure information for activating a protection path on an APS channel and transmit the network failure information to another network device. The APS channel is divided into a plurality of fields. The plurality of fields includes a first field corresponding to at least one of failure state information and request state information, and the first field may be a field corresponding to protection type information.

The protection type information may include at least one of information about whether to use APS channel and information about a switching type.

The information about whether to use APS channel may correspond to one of unused encoding values in the first field.

The information about the switching type may be determined on the basis of different encoding values which define predetermined request information.

The predetermined request information may be information that is associated with at least one of the failure state information and the request state information and may be an information having the lowest priority.

The APS channel may be associated with at least one of APS-specific information and APC-specific information.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a diagram showing APS channel formats according to the related art;

FIG. 2 is a table showing encoding of request and state fields in APS channels according to the related art;

FIG. 3 is a table showing APS channel sizes required for supporting 1+1 protection switching on the basis of a protection switching method and the APS channel formats according to the related art;

FIG. 4 is a table illustrating a method of encoding request and state fields according to an exemplary embodiment of the present disclosure; and

FIG. 5 is a flowchart illustrating operations of a network device according to an exemplary embodiment of the present disclosure.

### DETAILED DESCRIPTION OF EXEMPLARY EMBODIMENTS

Terms used in the present disclosure are used only to describe specific embodiments and are not intended to limit the scope of other embodiments. A singular expression includes a plural expression unless explicitly indicated otherwise in the context. Terms including technical and scientific terms and used herein may have the same meaning as commonly understood by those skilled in the technical field to which the present disclosure pertains. Among terms used herein, those defined in a commonly used dictionary may be interpreted as having a meaning identical or similar to the meaning in the content of the related art, and are not interpreted as in an ideal or excessively formal meaning unless clearly defined in the present disclosure. In some cases, even terms defined in the present disclosure are not interpreted as excluding embodiments of the present disclosure.

In various embodiments of the present disclosure described below, hardware-based approaches will be illustrated. However, various embodiments of the present disclosure include technology employing both hardware and software, and do not exclude software-based approaches.

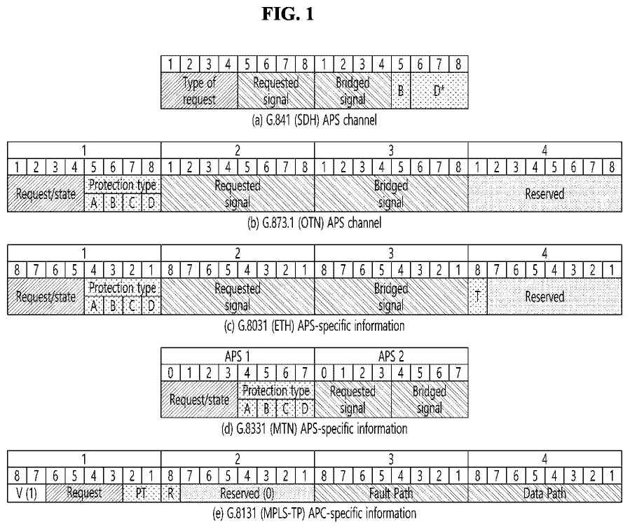

The present disclosure is directed to minimizing the size of APS channel on the basis of protection switching according to the related art. First, information on the formats and sizes of APS channels according to the related art will be described with reference to FIGS. 1 to 3.

Referring to FIG. 1, APS channels according to the related art are divided into separate fields according to the attributes of information and may have sizes of two bytes to four bytes.

In defining standards for transport networks for accommodating subscribers to a low-speed service of about 10 Mbps, such as fgOTN, fgMTN, and the like, the size of APS channels or APS-specific information for protecting each individual low-speed subscriber is an important element that determines overall network transmission efficiency, and thus it is necessary to minimize the size. According to a bidirectional 1+1 protection switching method currently agreed upon in the International Telecommunication Union Telecommunication Standardization Sector (ITU-T) for fgOTN and fgMTN, the minimum size of each field in an APS channel is as follows.

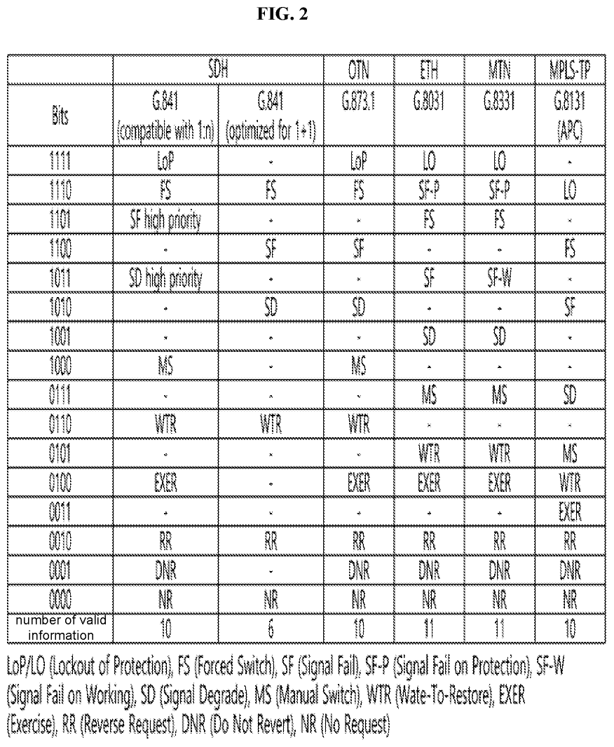

(1) Request/state field: it is necessary to store a failure state of a working or failure path, such as signal failure (SF), signal degrade (SD), or the like, an administrator command, such as lockout of protection (LoP), forced switch (FS), manual switch (MS), protocol exercise (EXER), or the like, and a protocol state, such as wait-to-restore (WTR), no request (NR), or the like. Request/state fields defined in APS channels of transport network technologies are shown in FIG. 2. In the case of SDH protection switching optimized for 1+1 protection switching, 6 signals are required, and 10 or 11 signals are required otherwise. Accordingly, when fgOTN and fgMTN protection switching methods are based on SDH protection switching optimized for 1+1 protection switching, a request/state field of three bits is required at the minimum, and a minimum of four bits are required otherwise.

(2) Requested signal (or failure path in the case of MPLS-TP) field: in the case of 1+1 protection switching, extra traffic is not supported, and only one normal traffic signal is protected. Accordingly, one bit is required for distinguishing between a null signal and a normal signal. However, in the case of SDH protection switching optimized for 1+1 protection switching, two bits are required for indicating two working paths in addition to a null signal.

(3) Bridged signal (or data path in the case of MPLS-TP) field: in the case of 1+1 protection switching, a normal signal is always bridged to a protection path, and thus this field may be omitted. However, in the case of SDH protection switching or MPLS-TP protection switching, one bit is required due to the operating method.

(4) Protection type field: except for SDH protection switching that does not support interoperation between different end-to-end protection switching mechanisms, technologies require one bit to indicate whether to use APS channel and one bit to indicate a switching type (unidirectional or bidirectional). (Protection architecture (1+1, 1:n) information may be omitted because it is limited to 1+1 protection switching, and operation type (revertive, non-revertive) information is unnecessary for end-to-end protection switching interoperation)

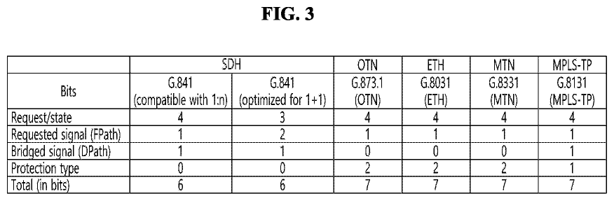

When a protection switching method and APS channel formats according to the related art are used, minimum APS channel sizes required for providing 1+1 protection switching to an fgOTN and an fgMTN are six or seven bits as shown in FIG. 3.

Although the present disclosure is based on a protection switching method according to the related art, a different format from APS channel formats according to the related art is defined to further reduce the sizes of APS channels.

According to the present disclosure, protection type information required for coordination between end-to-end protection switching operations is included in the request/state field of an APS channel so that the size of the APS channel can be minimized.

A request/state field of an APS channel defined in a transport network protection switching method according to the related art may include multiple unused encoding values as shown in FIG. 2. In the case of SDH protection switching optimized for 1+1 protection switching, a request/state field according to the related art has a size of four bits. However, the number of pieces of valid information required for protection switching is six and thus expressed with three bits. In this case, there are two unused encoding values. Since methods other than SDH protection switching optimized for 1+1 protection switching employ 10 or 11 encoding values, a request/state field has a size of four bits. In this case, there may be five or six unused encoding values.

Among pieces of protection type information, two pieces of information required for coordination between end-to-end protection switching operations, that is, whether to use APS channel and a switching type, may be included in a request/state field as follows.

(1) Whether to use APS channel: one of unused encoding values may be used. A node that is set to operate in a protection switching mode, such as 1+1 unidirectional protection switching, in which it is unnecessary to exchange information through an APS channel, may fill a request/state field with a specific unused encoding value and transmit the unused encoding value. When a receiving node receives the request/state of the specific unused encoding value, it is recognized that the counterpart node does not use an APS channel. Otherwise, it is recognized that the counterpart node uses an APS channel.

(2) Switching type: among pieces of request/state information, No Request (NR) which is ranked the lowest in priority may be defined as two different encoding values to distinguish between types of switching.

As described above, whether to use APS channel is displayed using an encoding value which is unused in the request/state field of an APS channel, and a switching type is displayed using one of two NRs (NRu and NRb) which may be recognized the same as an NR according to the related art by a protection switching state machine. Accordingly, it is possible to provide protection type information required for end-to-end protection switching coordination while using a protection switching state machine according to the related art without any change.

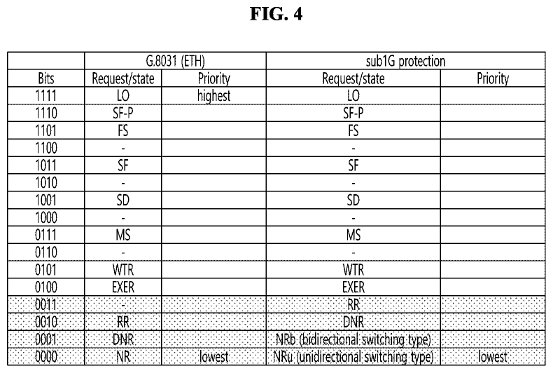

FIG. 4 is a table illustrating a method of encoding request and state fields according to an exemplary embodiment of the present disclosure.

Specifically, the method of encoding request/state fields illustrated in FIG. 4 maybe used for defining a 1+1 protection switching method of an fgOTN and an fgMTN based on G.8031 (ETH) protection switching.

The present disclosure is not limited to application of G.8031 (ETH), and the method of the present disclosure can be applied to any protection switching method according to the related art such as G.841 (SDH), G.873.1 (OTN), G.8331 (MTN), G.8131 (MPLS-TP), and the like.

Referring to FIG. 4, whether to use APS channel may be displayed using one of unused encoding values. A node that is set to operate in a protection switching mode, such as 1+1 unidirectional protection switching, in which it is unnecessary to exchange information through an APS channel, may fill a request/state field with a specific unused encoding value and transmit the unused encoding value. When a receiving node receives the request/state of the specific unused encoding value, it is recognized that the counterpart node does not use an APS channel. Otherwise, it is recognized that the counterpart node uses an APS channel. When a node using an APS channel receives a specific unused encoding value from a counterpart node, the node may switch to a 1+1 unidirectional protection switching mode in which no APS channel is used so that protection switching operations are coordinated with each other.

Types of switching may be distinguished by defining NR which is ranked the lowest in priority as two different encoding values.

FIG. 4 is an exemplary embodiment in which the present disclosure is applied to G.8031 (ETH) protection switching. As shown in FIG. 4, it is defined that an NRu encoded into 0b0000 indicates the unidirectional switching type, and an NRb encoded into 0b0001 indicates the bidirectional switching type, and thus a receiving node can recognize the switching type of the counterpart node. When a node operating in a bidirectional switching type receives an NRu from the counterpart node, the node may change its switching type to the unidirectional switching type so that end-to-end protection switching coordination can be performed.

An NRu and an NRb may be considered the same request/state as an NR according to the related art by a protection switching state machine. For example, when a received request/state field has a value of 0b000x, an NR is delivered to the state machine so that an NR is recognized by the state machine. Also, when a received request/state field has a value of 0b0000, the unidirectional switching type is delivered to an existing protection switching coordination logic as the switching type information of the counterpart node. And when a received request/state field has a value of 0b0001, the bidirectional switching type is delivered to the existing protection switching coordination logic as the switching type information of the counterpart node. Accordingly, necessary information can be provided without additional information exchange through a separate field.

With regard to whether to use APS channel, a node which is set not to use APS channel has no request/state information to send and thus may transmit an unused encoding value regardless of a request/state of the node.

However, the operation of indicating the switching type mentioned above may be valid only when a node is in a NR state. For example, when a node has a request/state other than an NR, it may not be possible to indicate whether to use APS channel and switching type information. However, protection type information is configured by an administrator in the early stage of network configuration, and thus such a limitation may not be problematic. Nevertheless, in case that the switching type of a network needs to be changed for the purpose of maintenance while the network is in operation (particularly, in a certain protection switching state), it is possible to send the changed switching type immediately by setting the following appropriate administrator commands in advance.

(1) When a protection path is in use (e.g., a working path failure/degradation): (first operation) sets a Forced Switch (FS) command to the counterpart node of a (local) node trying to change the switching type so that an NRu or NRb suitable for a current switching type is transmitted from the local node while the protection path is maintained, (second operation) changes the switching type of local node so that an NRu or NRb is transmitted, and (third operation) clears the FS command at the counterpart node.

(2) When a working path is in use (e.g., LoP): (first operation) sets a Lockout of Protection (LoP) command to the counterpart node of a (local) node trying to change the switching type, and clears the LoP command at the local node so that an NRu or NRb suitable for a current switching type is transmitted from the local node while the working path is maintained, (second operation) changes the switching type of local node so that an NRb or NRu is transmitted, and (third operation) sets the LoP command to the local node again, and then clears the LoP command at the counterpart node.

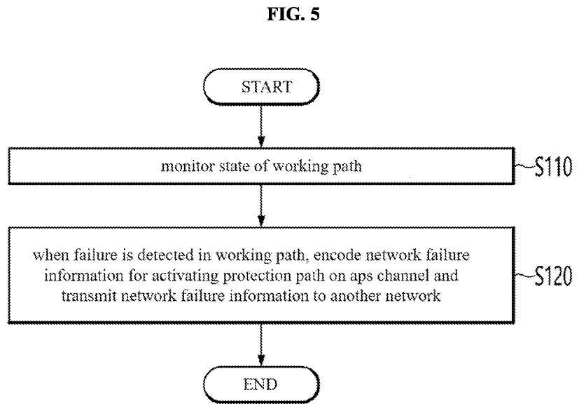

FIG. 5 is a flowchart illustrating operations of a network device according to an exemplary embodiment of the present disclosure.

A network device is hardware configured to communicate, manage, or process data in a computer network and may be referred to as a router, a switch, a hub, or the like. In APS, a network device may perform a function of routing data packets between networks or processing and transmitting data packets in a local network.

In operation S110, the network device monitors a state of a working path.

APS is a technology for minimizing service interruption by rapidly switching to a backup (protection) path when a failure occurs in a network. In detail, monitoring a working path may include the following operations.

State monitoring: the network device may continuously monitor the state of the working path. Here, the state of the working path may include states resulting from various problems such as physical damage to an optical fiber cable, a power supply problem, a data transmission rate reduction, and the like.

Failure detection: when a failure occurs in the working path, the network may detect the failure and report information on the occurrence of the failure to an APS function block.

Path switching: an APS system may rapidly switch from the failed working path to a backup path.

In operation S120, when a failure is detected in the working path, the network device encodes network failure information in the APS channel and transmits the network failure information to the counterpart network device in order to activate the protection path.

The APS channel is divided into a plurality of fields, and the plurality of fields may include a first field corresponding to at least one of failure state information and request state information.

Also, the first field may be a field corresponding to protection type information.

The protection type information may include at least one of information about whether to use APS channel and information about a switching type, and the information about whether to use APS channel may correspond to one of unused encoding values in the first field.

The information about the switching type may be determined on the basis of different encoding values which define predetermined request information, and the predetermined request information may be information that is associated with at least one of the failure state information and the request state information and ranked the lowest in priority.

The APS channel may be associated with at least one of APS-specific information and APC-specific information.

A device and method according to various exemplary embodiments of the present disclosure implement a 1+1 protection switching method of an fgOTN and an fgMTN for reducing the size of an APS channel compared to an APS channel format according to the related art on the basis of a protection switching method according to the related art, and improve efficiency of an overall network accordingly.

Effects of the present disclosure are not limited to that described above, and other effects which have not been mentioned above will be clearly understood by those skilled in the technical field to which the present disclosure pertains from the above description.

Methods of embodiments described in the claims or specification of the present disclosure may be implemented in the form of hardware, software, or a combination thereof.

When the methods are implemented by software, a computer-readable storage medium for storing one or more programs (software modules) may be provided. The one or more programs stored in the computer-readable storage medium are configured for execution by one or more processors in an electronic device. The one or more programs include instructions that cause the electronic device to execute methods of embodiments described in the claims or specification of the present disclosure.

In the specific embodiments of the present disclosure described above, components included in the disclosure are expressed in a singular or plural number according to specific embodiments provided. However, the expression of the singular or plural number is selected appropriately for the presented situation for convenience of description. The present disclosure is not limited to singular or plural components, and even a component expressed in a plural number may be singular in number, or even a component expressed in a singular number may be plural in number.

Meanwhile, in the detailed description of the present disclosure, specific embodiments have been described, but various modifications are possible without departing from the scope of the present disclosure. Therefore, the scope of the present disclosure should not be limited to the described embodiments and should be determined by not only the scope of the following claims but also equivalents thereto.

What is claimed is:

1. An operating method of a network device for encoding automatic protection switching (APS) information, comprising:
monitoring a state of a working path; and
when a failure is detected on the working path, encoding network failure information for activating a protection path on an APS channel and transmitting the network failure information to another network device,
wherein the APS channel is divided into a plurality of fields,
the plurality of fields includes a first field corresponding to at least one of failure state information and request state information, and
the first field is a field corresponding to protection type information.

2. The operating method of claim 1, wherein the protection type information includes at least one of information about whether to use APS channel and information about a switching type.

3. The operating method of claim 2, wherein the information about whether to use APS channel corresponds to one of unused encoding values in the first field.

4. The operating method of claim 2, wherein the information about the switching type is determined on the basis of different encoding values which define predetermined request information.

5. The operating method of claim 4, wherein the predetermined request information is information that is associated with at least one of the failure state information and the request state information and ranked a lowest in priority.

6. A network device for encoding automatic protection switching (APS) information, comprising:
a transceiver; and
at least one controller operatively connected to the transceiver,
wherein the at least one controller is configured to monitor a state of a working path and, when a failure is detected in the working path, encode network failure information for activating a protection path on an APS channel and transmit the network failure information to another network device,
the APS channel is divided into a plurality of fields,
the plurality of fields includes a first field corresponding to at least one of failure state information and request state information, and
the first field is a field corresponding to protection type information.

7. The network device of claim 6, wherein the protection type information includes at least one of information about whether to use APS channel and information about a switching type.

8. The network device of claim 7, wherein the information about whether to use APS channel corresponds to one of unused encoding values in the first field.

9. The network device of claim 7, wherein the information about the switching type is determined on the basis of different encoding values which define predetermined request information.

10. The network device of claim 9, wherein the predetermined request information is information that is associated with at least one of the failure state information and the request state information and ranked a lowest in priority.
